(19) United States
(12) Patent Application Publication
(10) Pub. No.: US 2016/0189026 A1
(43) Pub. Date: Jun. 30, 2016

(54) Running Time Prediction Algorithm for WAND Queries

(71) Applicant: Universidad de Santiago de Chile, Santiago (CL)

(72) Inventors: Mauricio MARIN, Santiago (CL); Verónica Gil-Costa, Santiago (CL); Oscar Rojas, Santiago (CL)

(21) Appl. No.: 14/583,225

(22) Filed: Dec. 26, 2014

(51) Int. Cl. G06N 3/08; G06F 17/30

(52) U.S. Cl. CPC G06N 3/08; G06F 17/30864

(57) ABSTRACT

A prediction method for estimating the running time of WAND queries executed on a Web search engine which includes an off-line component using the Discrete Fourier Transform to models the index as a collection of signals to obtain characteristic vectors for query terms and an on-line feed-forward neural network with back-propagation to estimate the time required to process the incoming queries. The DFT is used to obtain values for six characteristics of the posting lists associated with the query terms. These characteristics are used to train a neuronal network which is used to predict the query execution time.

### BACKGROUND OF THE INVENTION

### Field of the Invention

The present invention relates to running time prediction algorithms for Web search engines.

### BRIEF SUMMARY OF THE INVENTION

The present invention includes a query time prediction method. The method is devised for the WAND query processing algorithm. The method is based on: (1) An off-line algorithm which uses the discrete Fourier transform which models the search index as a collection of signals to obtain patterns; (2) a low dimension (6 descriptors) characteristic vector is created for each term; and (3) an on-line feed-forward neural network with back-propagation which predicts the time required to select the top-K document results for incoming queries.

The discrete Fourier transform (DFT) is used to model different features of the query terms. These features include the number of documents of the posting lists, distribution of the most frequent documents for the terms, and time required to compute the top k (k=10 and k=10000) documents for each term.

The algorithm based on the DFT obtains a six dimension vector representing the terms. This process is executed off-line without affecting the performance of the on-line query search process.

The six dimension vector is used to train a neuronal network with six inputs neurons (one for each descriptor of the vector) and one output neuron. The neuronal network is used to predict the query execution time

The query vector is computed on-line, before accessing the neuronal network, however this process has a low cost because it uses information pre-computed off-line. To compute the query vector the algorithm adds the descriptors of its terms, so the query vector has also dimension six.

The present invention is devised for the WAND query processing algorithm and its extensions like the Block-Max WAND, which are pruning techniques used to avoid processing complete lists. Predicting the execution time of queries before they are actually solved by the WAND strategy finds useful application in scheduling query execution so that computations are evenly distributed on the available threads or among processors holding replicas of the inverted index.

### BRIEF DESCRIPTION OF DRAWINGS

For a fuller understanding of the invention, reference should be made to the following detailed descriptions, taken in consideration with the accompanying drawings, in which:

FIG. 1 Shows the inverted index data structure.

FIG. 2. Shows how the WAND algorithm works for a query with three terms “tree, cat and house”.

FIG. 3. Shows how the Bloc-Max WAND algorithm works.

FIG 4. Is a diagrammatic view of the steps executed by the query time prediction method.

FIG. 5. Is a view of the score distribution of the posting lists of three terms.

FIG. 6. Is the discrete Fourier transform formulae.

FIG. 7. Is a diagrammatic view of the steps followed by the off-line component of the prediction algorithm.

FIG. 8. Is a diagrammatic view of the steps followed by followed by the on-line component.

### DETAILED DESCRIPTION OF THE PREFERRED EMBODIMENT

Provided is an efficient method for predicting query response times in a Web search engine, where Web documents are indexed using an inverted file data structure and are retrieved as results for user queries. The method is devised for the WAND (and its extensions like the Block-Max WAND) query processing algorithm. The method is composed on two components: 1) an off-line module executing the discrete Fourier Transform (DFT) which models the index as a collection of signals to obtain patterns, it creates a low dimension (6 descriptors) characteristic vector for each term; and 2) and on-line feed-forward neural network with back-propagation.

This inverted file or inverted index is a well known data structure used in large scale Web search engines to index Web documents. It enables the fast determination of the documents that contain the query terms and contains data to calculate document scores for ranking. The index is composed of a vocabulary table and a set of posting lists. The vocabulary table contains the set of relevant terms found in the document collection. Each of these terms is associated with a posting list which contains the document identifiers where the term appears in the collection along with data used assign a score to the document. To solve a query, it is necessary to get from the posting lists the set of documents associated with the query terms and then to perform a ranking of these documents in order to select the top-k documents as the query answer.

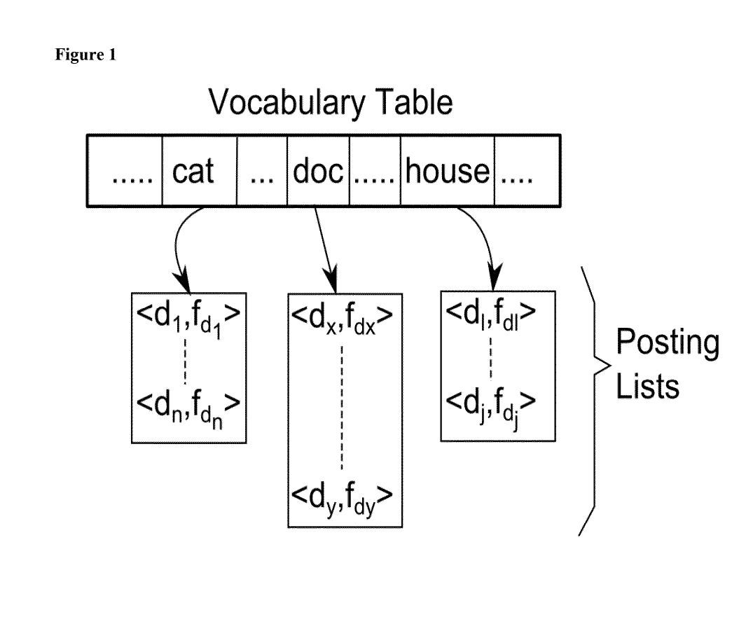

FIG. 1 shows an inverted file composed by a vocabulary table containing the terms “cat”, “dog” and “house”. Each term has a posting lists with pairs of <d,f_{d}>, where d is the document identifier where the term appears, and f_{d}, is the number of occurrences of the term in the document.

The WAND algorithm is executed on an inverted index, which is usually kept in compressed format. It is used to process each query by looking for query terms in the inverted index and retrieving each posting list. The algorithm uses a heap to keep the current top-k documents where in the root is located the document with least score. The root score provides a threshold value which is used to decide the full score evaluation of the remaining documents in the posting lists associated with the query terms. To this end, the algorithm iterates through posting lists to evaluate them quickly using a pointer movement strategy based on pivoting. Pivot terms and pivot documents are selected to move forward in the posting lists which allow skipping many documents that would have been evaluated by an exhaustive algorithm. Each term has an upper bound UBₜ which corresponds to its maximum contribution to any document score in the collection.

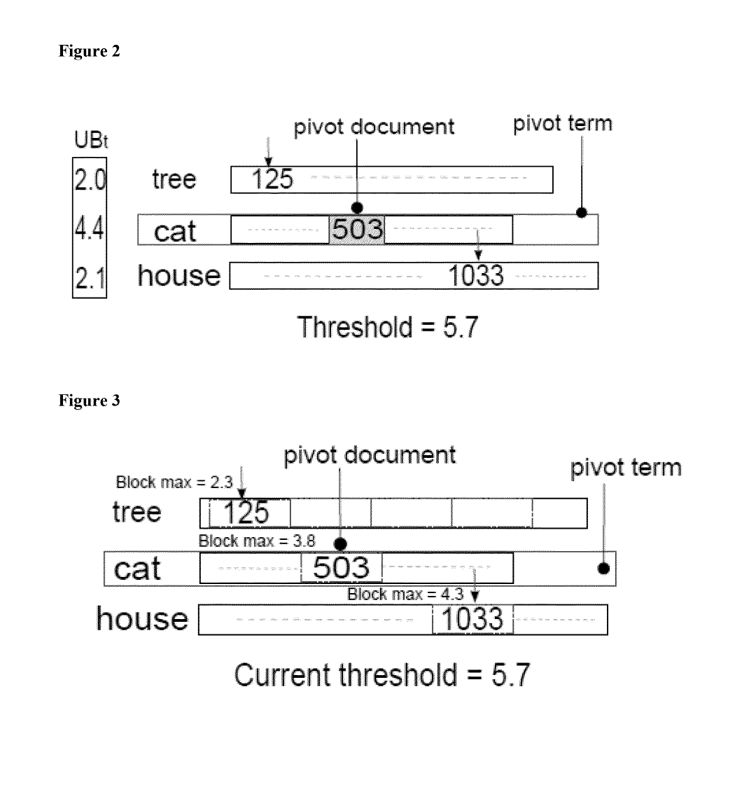

FIG. 2 shows how the WAND algorithm works for a query with three terms “tree, cat and house”. First, posting lists of the query terms are sorted by docIDs upper bounds (UBs) from top to bottom. Then the upper bounds of the terms are added until a value greater or equal to the threshold is reached. In this example, the sum of the UBs of the first two terms is 2+4.4=6.4 greater than the threshold value. Thus the term cat is selected as the pivot term. Assuming that the current document in this posting list is “503”, this document becomes the pivot document. If the first two posting lists do not contain the document 503, the algorithm proceeds to select the next pivot. Otherwise, the score of the document 503 is computed. If the score is greater or equal to the threshold value, the heap is updated by removing the root document and adding the new document. This iterative algorithm is repeated until there are no documents to process or until it is no longer possible for the sum of the upper bounds to exceed the current threshold.

The Block-Max WAND extends the WAND algorithm by using compressed posting lists organized in blocks (see FIG. 3). Each block stores the upper bound (Block max) for the documents inside that block in uncompressed form, thus enabling to skip large parts of the posting lists by skipping blocks.

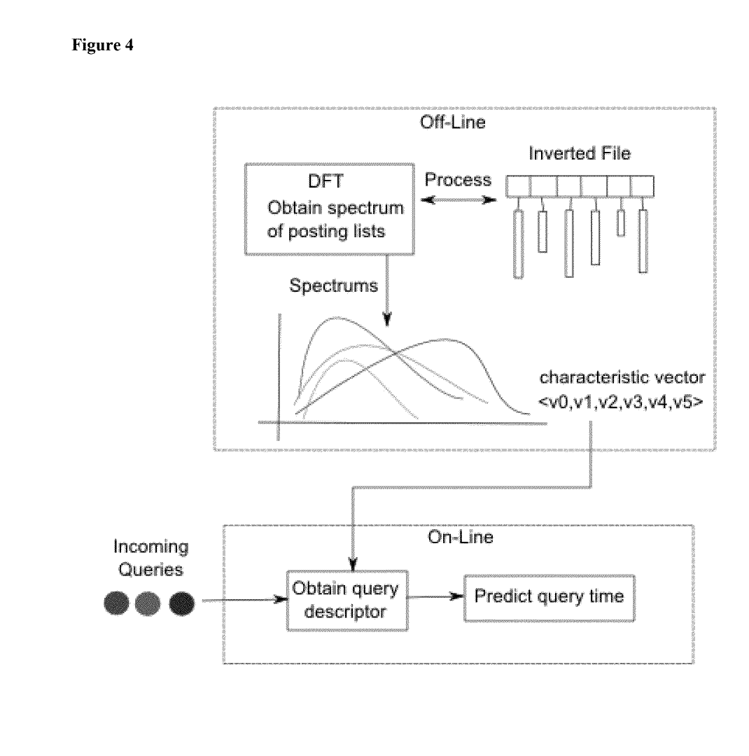

The information regarding the score distribution w(t, d), the location of documents representing the upper bounds in posting lists and the length of the posting lists, varies from term to term. FIG. 4 shows the score distribution of the posting lists of three terms. The x-axis shows the documents sorted in ascending order by their identifiers, and the y-axis shows the score w(t, d). Thus, a good query representation requires to combine different features that allows to establish a mathematical relationship between the time required to process the query and the information stored in the inverted index.

The prediction algorithm uses the DFT to obtain the spectrum of the posting lists of terms stored in the inverted file. The information obtained with the DFT is used to feed a feed-forward neural network with back-propagation which computes the estimated query response times.

FIG. 5 shows a general description of the steps followed by the query time prediction method. The off-line component uses the DFT to compute a characteristic vector of posting lists of the terms stored in the inverted file. These vectors are used to compute the characteristic vector of incoming queries, which is used by a neuronal network to predict the query time.

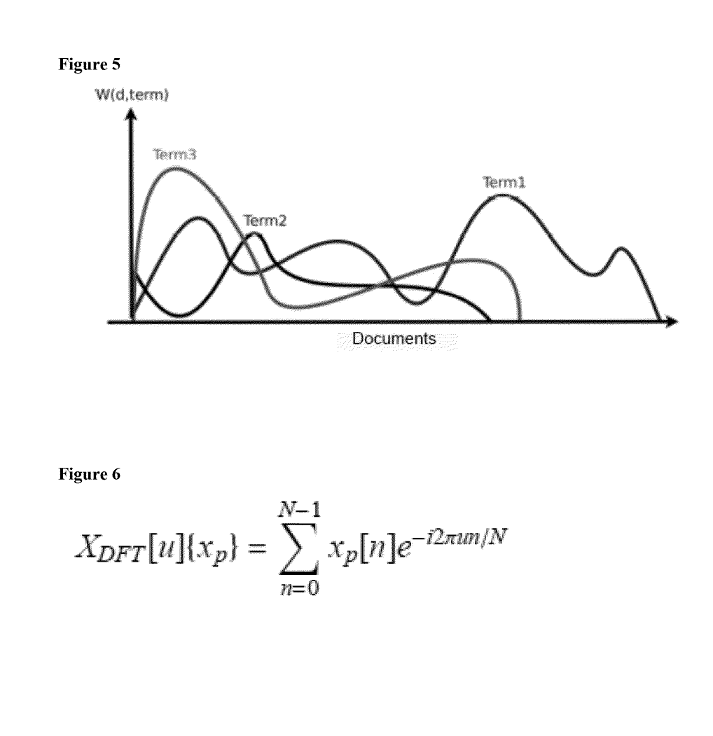

The off-line component of the prediction algorithm works as follows. Given a query q containing the terms tₙ with n>=1, where each term has a posting list Lₜ containing pairs <d, w(d, t)> where d is the document identifier and w(d, t) is the score of the term in the document (e.g. the frequency of occurrence of the term t in the document d). The algorithm used information regarding the frequency spectrum of density functions Oₜ obtained from the posting lists of the terms tₙ∈q, and also considers the information related to the spectrum of frequency of the processing time T(tₙ,k) for each term tₙ required to retrieval the top-k document results. The spectrum of frequencies is obtained with the discrete Fourier transform DFT (FIG. 6). In addition, the algorithm used: (a) the size of each posting lists St=|Lₜ| (i.e. the number of documents where the term appears), and (b) the processing time for T(t, 10) and for T(t, 10000). Then, terms are described with a six dimension characteristic vector <v₀,v₁,v₂,v₃,v₄,v₅>.

The first descriptor of the vector (v₀) is the Density Spectral Power (DSP) computed as the spectral power density of the of Oₜ in the fundamental frequency F= 1/10. Te second descriptor v1, is the magnitude of the frequency spectrum of the DFT obtained for the vector containing the processing times T(t, k) of a term t at frequency T=¼. The vector elements are <T(t, 10), T(t, 100), T(t, 1000), T(t, 10000) >, where T(t, k) is processing time computed for the term t while retrieving the top-k documents results. v2, is the sum of the contents of the vector Tₜ. The descriptors v3 and v4 are the processing times of Lt for k=10 and k=10, 000. These values are pre-computed. Finally, v5 is the number of documents of the posting list Lt.

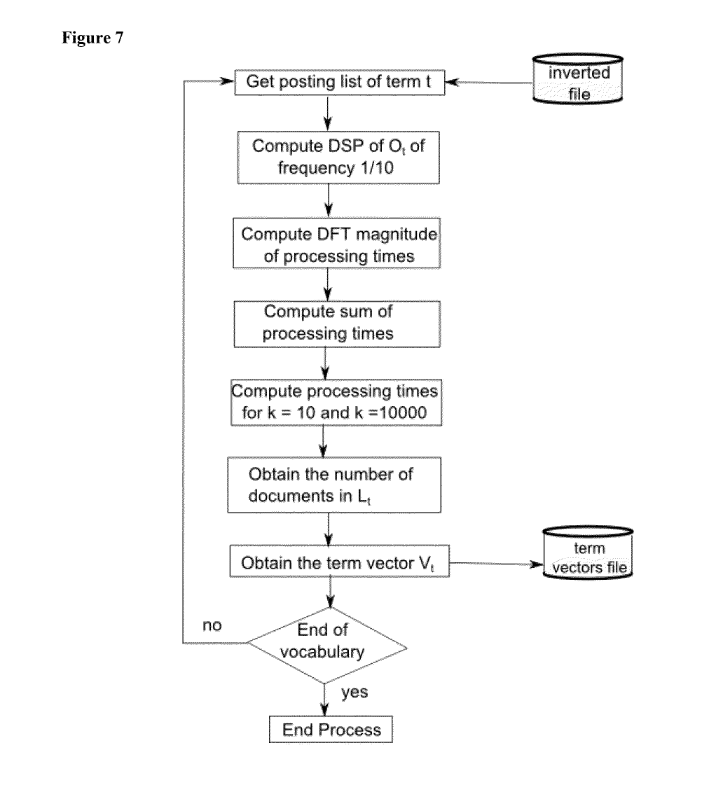

FIG. 7 shows a general description of the steps followed by the off-line component.

The density function X_{DFT} of the posting lists of the terms, describes the search space of each posting lists. The X_{DFT} of the processing times functions T(t, k) describes the differences of the time required to process the posting list of a term t.

The query descriptor V_{q}, is computed on-line by adding the descriptors of its terms. So the query vector V_{q} has dimension six.

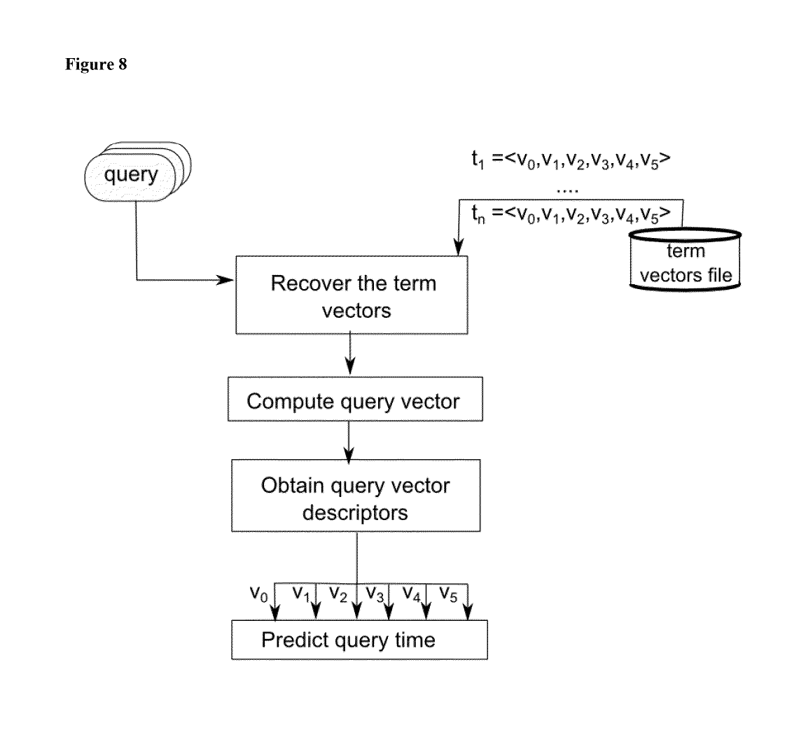

FIG. 8 shows the general description of the steps followed by the on-line component of the prediction algorithm. For new queries, a six dimension characteristic vector is built using the DFT information computed off-line. Namely, a query vector is built by adding the characteristic vectors of the terms forming the query. Each descriptor of the query vector is an input of a feed-forward neural network with back-propagation. This network estimates the time required to process the query using the Block-Max WAND query processing algorithm.

### Hardware and Software Infrastructure Examples

The present invention may be embodied on various multi-core computing platforms. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic magnetic, optical, electromagnetic, infrared, or semiconductor system, apparatus or device, or any suitable combination of the foregoing. More specific examples (a non-exhaustive list) of the computer readable storage medium would include the following: an electronic connection having one or more wires, a portable computer diskette, a hard disk, a random access memory (RAM), a read-only memory (ROM), an erasable programmable read-only memory (EPROM or Flash memory), an optical fiber, or any suitable combination of the foregoing. In the context of this document, a computer readable storage medium maybe any tangible medium that contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of variety of forms, including, but not limited to, electro-magnetic, optical, or any suitable combination thereof. A computer readable signal maybe any computer readable medium that is not computer readable storage medium, and that can communicate, propagate, or transport a program for use by or in connection with an instruction execution system, apparatus, or device.

Program code embodied on a computer readable medium maybe transmitted using any appropriate medium, including but not limited to, wire-line, optical fiber cable, radio frequency, etc., or any suitable combination of the foregoing. Computer program code for carrying out operations for aspects of the present invention may be writing in any combination of one or more programming languages, including an object oriented programming language such as Java, C++ or the like and conventional procedural programming languages such as the “C” programming language or similar programming languages.

Aspects of the present invention are described below with the reference to the flowchart illustration and/or block diagrams of methods, apparatus (systems) and computer program products according to the embodiments of the invention. It will be understood that each block of the flowchart illustrations and/or block diagrams, can be implemented by computer program instructions. These computer program instructions may be provided to a processor or a general purpose computer, or the programmable data processing apparatus to produce a machine, such that the instructions, which execute via the processor of the computer or other programmable data processing apparatus, creates means for implementing the functions/acts specified in the flowchart and/or block diagram block or blocks.

These computer programmable instructions may also be stored in a computer readable medium that can direct a computer, other programmable data processing apparatus, or other devices to function in a particular manner, such that the instructions stored in the computer readable medium produce an article of manufacturing including instructions which implement the function/act specified in the flowchart and/or block diagram block or blocks.

The computer program instructions may be also loaded onto a computer, other programmable data processing apparatus, or other devices to cause a series of operational steps to be performed on a computer, other programmable apparatus, or other devices to produce a computer implemented process such that the instructions which execute on the computer or other programmable apparatus provide process for implementing the functions/acts specified in the flowchart and/or block diagram block or blocks.

### Glossary of Claim Terms

WAND: Weighted AND query processing algorithm.

Ranking algorithm: Determines the relevance of a document to a given query.

Pruning Technique: Technique used to avoid processing the complete index when computing the top-K document results.

Upper bound (UBₜ): Maximum score of the term t in the document collection.

Score(d,q): Determine the relevance of the document d to the query q.

The advantages set forth and above, and those made apparent from the foregoing description, are efficiently attained. Since certain change may be made in the above construction without departing from the scope of the invention, it is intended that all matters contained in the foregoing description or shown in the accompanying drawings shall be interpreted as illustrative and not in a limiting sense.

What is claimed is:

1. The prediction method providing a system for estimating the running time of queries executed on a Web search engine, comprising:
an off-line component using the Discrete Fourier Transform (DFT) which calculates values for six characteristics of the posting lists associated with the query terms; and
an on-line feed-forward neural network with back-propagation which estimates the time required to process the incoming queries.

2. The method according to claim 1, wherein the off-line component based on the DFT obtains a six dimension vectors representing terms and includes the following steps:
a. calculating the Density Spectral Power (DSP) as the spectral power density of the density functions of the terms in the fundamental frequency F= 1/10;
b. calculating the magnitude of the frequency spectrum of the DFT obtained for the vector containing the processing times T(t, k) of a term t at frequency T=¼;
c. calculating the sum of the contents of the vector T.
d. calculating the processing times for k=10 and k=10,000; and
e. retrieving the number of documents of the posting list Lt.

3. The method according to claim 1, wherein the on-line component includes the following steps:
a. calculating the query vector using information pre-computed off-line; and
b. building the query vector by adding the descriptors of its terms, so the query vector has also dimension six.

4. The method according to claim 1, wherein:
the system has the capability of adjusting its query time estimation; and
said adjusting comprises the calculation of the processing times of the terms either:
a. on multi-thread computers with share-memory platforms; or
b. on cluster of computers with distributed memory platforms.

5. The method according to claim 2, wherein:
the system has the capability of adjusting its query time estimation; and
said adjusting comprises the calculation of the processing times of the terms either:
a. on multi-thread computers with share-memory platforms; or
b. on cluster of computers with distributed memory platforms.

6. The method according to claim 3, wherein:
the system has the capability of adjusting its query time estimation; and
said adjusting comprises the calculation of the processing times of the terms either:
a. on multi-thread computers with share-memory platforms; or
b. on cluster of computers with distributed memory platforms.
